(19) United States
(12) Patent Application Publication
(10) Pub. No.: US 2005/0222303 A1
(43) Pub. Date: Oct. 6, 2005

(54) Compositions and methods for producing highly filled materials

(76) Inventor: Jeffrey Jacob Cernohous, Hudson, WI (US)

Correspondence Address: Dr. Jeffrey J. Cernohous, 643 Hillary Farm Road, Hudson, WI, 54016, US

(21) Appl. No.: 11/099,752

(22) Filed: Apr. 6, 2005

Related U.S. Application Data
(60) Provisional application No. 60/559,935, filed on Apr. 6, 2004.

(51) Int. Cl. C08K 5/34

(52) U.S. Cl. 524/13

(57) ABSTRACT

The present invention relates to compositions and methods for producing highly filled polymers, and more particularly to the use of ultra high molecular weight polyethylene to enhance the mechanical properties filled polymeric materials.

### CROSS REFERENCE TO RELATED APPLICATIONS

This application claims priority to provisional patent application 60/559,935 filed on Arp. 6, 2004.

### STATEMENT OF FEDERALLY FUNDED SPONSORED RESEARCH OR DEVELOPMENT

This invention was not supported by any federal funding.

### FIELD OF THE INVENTION

The present invention relates to highly filled polymers that contain Ultra High Molecular Weight Polyethylene (UHMWPE). In particular, it has been found that the present invention relates a highly filled composite with an markedly improved tensile and impact properties without sacrificing flexural strength.

### BACKGROUND OF THE INVENTION

The present invention relates to compositions and methods producing highly filled materials, and more particularly to the use of Ultra High Molecular Weight Polyethylene (UHMWPE) as an additive in highly filled polymeric materials. It has been found that addition of UHMWPE to highly filled polymers markedly improves the physical properties of such compositions.

The use of UHMWPE in composites formulations at relatively high loading levels is well known in the art. For example, U.S. Pat. Nos. 5,079,287 and 5,889,102 describe filled polymer compositions containing UHMWPE that have improved wear properties. US 6,521,709 describes polypropylene compositions having 5 to 90% by weight UHMWPE that have improved tensile properties. However, compositions that were exemplified all had very high levels of UHMWPE, and the flexural properties were severely compromised to achieve improved tensile properties. Surprisingly, the present invention finds that the tensile and impact properties of highly filled polymers are greatly improved, without sacrificing the flexural properties when low levels of UHMWPE are added to the composition.

### BRIEF SUMMARY OF THE INVENTION

Polymeric materials, hereinafter referred to as polymeric matrices, and are often combined with certain fillers and/or additives to both enhance the economics and to impart desired physical characteristics to the processed material. The fillers may include various organic material or inorganic material mixed throughout the polymeric host material. For example, cellulosic fiber or flour is often included with certain polymers to make a composite that is suitable as a building material upon melt processing. However, adding high levels of filler to polymeric matrices has the general effect of increasing overall stiffness of the composite while sacrificing the overall toughness. Impact modifiers are well known in the art, and can be added to filled polymeric matrices to improve toughness. However, because they are typically soft, elastomeric materials the stiffness of the impact modified composites is sacrificed. The present invention offers an economical solution to this problem by using UHMWPE as an additive to such compositions.

### DETAILED DESCRIPTION OF THE INVENTION

The compositions of this invention include a polymeric matrix, a filler and UHMWPE. This invention also contemplates methods for melt processing such compositions. Compositions of this invention have specific application as building materials and automotive components.

The polymeric matrix functions as the host polymer and is a primary component of the melt processable composition. A wide variety of polymers conventionally recognized in the art as suitable for melt processing are useful as the polymeric matrix. The polymeric matrix includes polymers that are commonly combined with fillers using melt processing techniques. They include both hydrocarbon and non-hydrocarbon polymers. Examples of useful polymeric matrices include, but are not limited to, polyamides, polyimides, polyurethanes, polyolefins, polystyrenes, polyesters, polycarbonates, polyketones, polyureas, polyvinyl resins, polyacrylates and polymethylacrylates.

Preferred polymeric matrices include, high density polyethylene (HDPE), low density polyethylene (LDPE), linear low density polyethylene (LLDPE), polypropylene (PP), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polyvinylchloride (PVC), fluoropolymers, liquid crystal polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl esters or combinations thereof Most preferred polymeric matrices are polyolefins and polystryenes.

Polymeric matrices that are derived from recycled plastics are also preferred as they are often lower cost. However, because such materials are often derived from materials coming from multiple waste streams, they can have vastly varied mechanical properties. Adding UHMWPE to compositions containing recycled plastics and fillers can be particularly advantageous for this reason.

The polymeric matrix is included in the melt processable compositions in amounts of about typically greater than about 20% by weight. Those skilled in the art recognize that the amount of polymeric matrix will vary depending upon, for example, the type of polymer, the type of filler, the processing equipment, processing conditions and the desired end product.

The melt processable composition may also include other additives to impart specific attributes on the composite compostion. Non-limiting examples of such additives include antioxidants, lubricants, light stabilizers, antiblocking agents, heat stabilizers, biocides, compatibilizers, flame retardants, plasticizers, tackifiers, colorants and pigments.

The polymeric matrix may be incorporated into the melt processable composition in the form of powders, pellets, granules, or in any other extrudable form.

Conventionally recognized polymeric matrices and fillers may be utilized to form the polymeric mixture suitable for melt processing. The fillers of this invention are generally those organic or inorganic materials utilized in the polymer composite industry. Non-limiting examples of fillers include pigments, carbon fibers, anti-block agents, glass fibers, carbon black, aluminum oxide, silica, mica, cellulosic materials.

In another aspect of the invention, a cellulosic material serves as the filler in the polymeric matrix to form a polymeric mixture. Such composites have found extensive application and use as building materials. Cellulosic materials are commonly utilized in melt processable compositions to impart specific physical characteristics or to reduce cost of the finished composition. Cellulosic materials generally include natural or wood based materials having various aspect ratios, chemical compositions, densities, and physical characteristics. Non-limiting examples of cellulosic materials include wood flour, wood fibers, sawdust, wood shavings, newsprint, paper, flax, hemp, rice hulls, corn hulls, kenaf, jute, sisal, peanut shells. Combinations of cellulosic materials may also be used in the melt processable composition.

The amount of filler in the melt processable composition may vary depending upon the polymeric matrix and the desired physical properties of the finished composition. Those skilled in the art of melt processing are capable of selecting an appropriate amount of an filler to match with a specific polymeric matrix in order to achieve desired physical properties of the finished material. Typically, the filler may be incorporated into the melt processable composition in amounts up to about 80% by weight.

Ultra high molecular weight polyethylene (UHMWPE) is utilized in this invention to improve the tensile and impact properties of the filled polymer matrix. Examples of UHMWPE products that are useful in this invention include GUR™ family of products marketed by Ticona (Summit, N.J.). A preferred grade of UHMWPE for this invention is GUR 4150.

The amount of UHMWPE present in the melt processable composition is dependent upon several variables, such as for example, the polymeric matrix, the type and amount of filler, the type of melt processing equipment, the processing conditions, and others. Those of skill in the art are capable of selecting an appropriate amount of polymer processing aid to achieve the desired improvement in mechanical properties. In a preferred embodiment, UHMWPE is used at 0.1 to 5.0% by weight of the composite. More preferably the UHMWPE level is between 0.25 and 3.0% and most preferably between 0.5 and 2.0%.

The melt processable composition of the invention can be prepared by any of a variety of ways. For example, the polymeric matrix and UHMWPE can be combined together prior to adding a filler by any of the blending means usually employed in the plastics industry, such as with a compounding mill, a Banbury mixer, or a mixing extruder in which the processing additive is uniformly distributed throughout the host polymer. UHMWPE and the host polymer may be used in the form, for example, of a powder, a pellet, or a granular product. The mixing operation is most conveniently carried out at a temperature above the melting point of the polymeric matrix, though it is also feasible to dry-blend the components in the solid state as particulates and then cause uniform distribution of the components by feeding the dry blend to a twin-screw melt extruder. The resulting melt-blended mixture can be either extruded directly into the form of the final product shape or pelletized or otherwise comminuted into a desired particulate size or size distribution and fed to an extruder, which typically will be a single-screw extruder, that melt-processes the blended mixture to form the final product shape.

Melt-processing typically is performed at a temperature from 150° to 280° C., although optimum operating temperatures are selected depending upon the melting point, melt viscosity, and thermal stability of the composition. Different types of melt processing equipment, such as extruders, may be used to process the melt processable compositions of this invention. Extruders suitable for use with the present invention are described, for example, by Rauwendaal, C., “Polymer Extrusion,” Hansen Publishers, p. 23-48, 1986.

The present invention also contemplates methods for melt processing the novel compositions. Non-limiting examples of melt processes amenable to this invention include methods such as extrusion, injection molding, blow molding, rotomolding and batch mixing.

The melt processable compositions may be utilized to make items such as building materials and automotive components. Examples include, residential decking, automotive interior components, roofing, siding, window components, and decorative trim.

### EXAMPLES

TABLE 1
Material Key for Examples

| Material | Description |
|---|---|
| PP | HB1602 12 MFI polypropylene commercially |
| | supplied by BP (Warrenville, IL) |
| HDPE | HD12450 12 MFI high density polyethylene |
| | commercially available from Dow Chemical Company |
| | (Midland, MI) |
| Impact Modifier | Engage 8407, an ethylene/α-olefin copolymer |
| | commercially available from Dupont-Dow Elastomers |
| | (Wilmington, DE) |
| UHMWPE | GUR 4150, commercially available from Ticona |
| | (Summit, NJ) |
| Wood Fiber | 40 mesh hardwood fiber commercially available |
| | from American Wood Fibers (Schofield, WI) |

Sample Preparation and Characterization

Composite samples were prepared and testing using the following protocol. Wood fiber was predried for 4 hours at 200° F. in a vacuum oven at less 0.1 mmHg. Resin (PP or HDPE), wood fiber and additives (i.e., UHMWPE or Engage 8407) were then dry mixed in a plastic bag and gravity fed into a 27 mm conical twin screw extruder fitted with a two strand die (commercial available from C. W. Brabender, South Hackensack, N.J.). All samples were processed at 75 RPM screw speed using the following temperature profile: Zone 1=145° C., Zone 2=185° C., Zone 3=200° C., Zone 4=200° C. The resulting strands were extruded and subsequently pelletized into ˜¼″ pellets. The resulting pellets were injection molded into test specimens following ASTM D63 8 (tensile) and D790 (flexural) specifications. Injection molding of composite formulations was performed using a 300 ton machine (commercially available from Engel Corporation, York, Pa.) having a barrel and nozzle temperature of 390° F. The flexural and tensile properties were subsequently tested as specified in the ASTM methods.

TABLE 2
Formulations of Comparative Examples 1-6 and Examples 1-6

| | | | | Impact | |
|---|---|---|---|---|---|
| Example | PP | HDPE | Wood Fiber | Modifier | UHMWPE |
| CE 1 | 50 | — | 50 | — | — |
| CE 2 | — | 50 | 50 | — | — |
| CE 3 | 45 | — | 50 | 5 | — |
| CE 4 | 40 | — | 50 | 10 | — |
| CE 5 | — | 45 | 50 | 5 | — |
| CE 6 | — | 40 | 50 | 10 | — |
| 1 | 49.5 | — | 50 | — | 0.5 |
| 2 | 49 | — | 50 | — | 1.0 |
| 3 | 48 | — | 50 | — | 2.0 |
| 4 | | 49.5 | 50 | | 0.5 |
| 5 | | 49 | 50 | | 1.0 |
| 6 | | 48 | 50 | | 2.0 |

As can be seen from Table 2, Comparative Examples 1-2 are composite formulations without and impact modifier or UHMWPE. Comparative Examples 3-6 are PP and HDPE based composite formulations having conventional levels of impact modifer present in the formulations. Examples 1-6 are PP and HDPE based composite formulations with UHMWPE levels varied from 0.5 to 2.0 weight % of the composite. Table 3 provides the tensile and flexural properties obtained for these formulations. As can be seen from the table, Comparative Examples 1-6 demonstrate that the addition of impact modifier into both the PP and HDPE based composite formulations improves the elongation at break values by more than 50% when compared to the unmodified composites (CE 1 and CE 2), however the flexural modulus and tensile strength of these composites is sacrificed by as much as 30%. However, Examples 1-6 show that the addition of relatively low levels of UHMWPE improves elongation at break values by as much as 50%, while only reducing flexural modulus by 5%.

TABLE 3
Flexural and Tensile Properties of Comparative
Examples 1-6 and Examples 1-6

| | Flexural | Flexural | Tensile | Tensile | |
|---|---|---|---|---|---|
| | Test Rate | Modulus | Test Rate | Strength | Elongation |
| Example | (in/min) | (MPa) | (in/min) | (MPa) | At Break (%) |
| CE 1 | 2 | 3817 | 5 | 25.7 | 5.1 |
| CE 2 | 2 | 2253 | 5 | 15.1 | 6.1 |
| CE 3 | 2 | 3011 | 5 | 19.6 | 6.6 |
| CE 4 | 2 | 2481 | 5 | 18.2 | 7.7 |
| CE 5 | 2 | 2046 | 5 | 12.8 | 9.1 |
| CE 6 | 2 | 1857 | 5 | 10.2 | 11.8 |
| 1 | 2 | 3868 | 5 | 27.0 | 6.8 |
| 2 | 2 | 3779 | 5 | 27.6 | 7.1 |
| 3 | 2 | 3665 | 5 | 28.0 | 7.6 |
| 4 | 2 | 2325 | 5 | 15.2 | 6.4 |
| 5 | 2 | 2538 | 50 | 15.5 | 7.9 |
| 6 | 2 | 2836 | 50 | 16.7 | 11.0 |

From the above disclosure of the general principles of the present invention and the preceding detailed description, those skilled in this art will readily comprehend the various modifications to which the present invention is susceptible. Therefore, the scope of the invention should be limited only by the following claims and equivalents thereof.

1. A melt processable composition comprising:
(a) 80 to 20% by weight of a polymeric matrix,
(b) 20 to 80% by weight of a filler; and
(c) 0.1 to 5% by weight ultra high molecular weight polyethylene

2. The composition of claim 1, wherein the filler is a cellulosic material selected from the group consisting of wood flour, wood fibers, sawdust, wood shavings, newsprint, paper, flax, hemp, rice hulls, corn hulls, kenaf, jute, sisal, peanut shells.

3. The composition of claim 1, wherein the filler is a wood fiber or flour.

4. The composition of claim 1, wherein the polymeric matrix is selected from the group consisting of high density polyethylene (HDPE), low density polyethylene (LDPE), linear low density polyethylene (LLDPE), polypropylene (PP), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polyvinylchloride (PVC), fluoropolymers, liquid crystal polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl ester

5. The composition of claim 1, wherein the polymeric matrix is a polyolefin.

6. The composition of claim 1, wherein the composition comprises 0.25 to 3% ultra high molecular polyethylene.

7. The composition of claim 1, wherein the composition comprises 0.5 to 2% ultra high molecular polyethylene.

8. A method for forming an article comprising melt-processing the composition of claim 1.

9. The method of claim 8 wherein said melt-processing includes extrusion, injection molding, batch mixing, rotomolding and blow molding.

10. The composition of claim 2, wherein said polymeric matrix is polyethylene and upon melt processing, said composition has an elongation at break of 7% or greater and a flexural modulus of 2300 MPa or greater.

11. The composition of claim 2, wherein said polymeric matrix is polypropylene and upon melt processing, said composition has an elongation at break of 6% or greater and a flexural modulus of 3200 MPa or greater.

12. A method for forming an article comprising melt-processing the composition of claim 2.

13. The method of claim 12, wherein polymeric matrix is polyethylene and, said composition has an elongation at break of 7% or greater and a flexural modulus of 2300 MPa or greater.

14. The method of claim 12, wherein polymeric matrix is propylene and said composition has an elongation at break of 6% or greater and a flexural modulus of 3200 MPa or greater.

15. The method of claim 12, wherein said method is utilized to form building materials and automotive components.
